(19) United States
(12) Patent Application Publication
(10) Pub. No.: US 2009/0187723 A1
(43) Pub. Date: Jul. 23, 2009

(54) SECURE STORAGE SYSTEM AND METHOD FOR SECURE STORING

(75) Inventors: Willem Jonker, Eindhoven (NL); Richard Brinkman, Enschede (NL); Stefan Jean Maubach, Nijmegen (NL)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 12/298,731

(22) PCT Filed: Apr. 17, 2007
(86) PCT No.: PCT/IB2007/051374

§ 371 Date: Dec. 16, 2008

(30) Foreign Application Priority Data
Apr. 27, 2006 (EP) 06113192.6

(51) Int. Cl. G06F 12/14; G06F 17/30; G06F 15/16

(52) U.S. Cl. 711/163; 726/29; 709/206; 711/E12.001; 711/E12.091

(57) ABSTRACT

According to an exemplary embodiment a method for securely storing a message comprises dividing a first message into a first plurality of shares, and storing the first plurality of shares on a storing host together with a second plurality of shares of at least a second message, wherein the storing is performed in a mixed manner.

The invention relates to a secure storage system, a method for secure storing, a method for retrieving a securely stored message, a computer readable medium, and a program element, in particular to a secure storage system which rely not solely on computational complexity of the underlying cryptographic principles.

Most crypto systems rely on the computational complexity of breaking them. Eventually, all these will be broken some day. That is, almost all crypto systems used today rely on the computational complexity of a brute force attack. They assume that the encryption function is computationally uninvertible, whereas it is known that there exists at least one inverse: the decryption function. Every crypto algorithm that uses a key can be broken by trying all possible keys. It is just a matter of waiting long enough for the computation to finish or for the computers to become fast enough. According to Moore's Law the processing power of computers is doubled every 18 months. Thus, what seems unbreakable now, will eventually be broken somewhere in the future. Normally this causes no problem since most data gradually loses its value and secrecy when time elapses. Other data, however, stays sensitive indefinitely. Medical data, for instance, should never be revealed to the public. Even when somebody died years ago, the descendants, who may have inherited some diseases from their (grand-)parents, would feel uncomfortable when this information would be publicly available.

It may be desirable to provide an alternative secure storage system, a method for secure storing, a method for retrieving a securely stored message, a computer readable medium, and a program element.

This need may be met by an alternative secure storage system, a method for secure storing, a method for retrieving a securely stored message, a computer readable medium, and a program element according to the independent claims.

According to an exemplary embodiment a method for securely storing a message comprises dividing a first message into a first plurality of shares, and storing the first plurality of shares on a storing host together with a second plurality of shares of at least a second message, wherein the storing is performed in a mixed manner.

According to an exemplary embodiment a method for retrieving a securely stored message, wherein the securely stored message is divided into a first plurality of shares, which is stored on a storing host in a mixed manner, wherein each of the shares is labelled, the method comprises sending a list comprising a fourth plurality of labels from a client to the storing host and transmitting the shares associated with the labels of the fourth plurality of labels from the storing host to the client host.

According to an exemplary embodiment a secure storage system for private messages comprises a storing host, wherein the storing host is adapted to store a plurality of private messages in a mixed manner, wherein each of the plurality of private messages is divided into a plurality of message shares.

According to an exemplary embodiment a computer readable medium is provided in which a program for secure storing a private message is stored, which program, when executed by a processor, is adapted to control a method comprising dividing a first message into a first plurality of shares, and storing the first plurality of shares on a storing host together with a second plurality of shares of at least a second message in a mixed manner.

According to an exemplary embodiment a computer readable medium is provided in which a program for retrieving a securely stored private message, which program, when executed by a processor, is adapted to control a method comprising sending a list comprising a fourth plurality of labels from a client to the storing host and transmitting the shares associated with the labels of the fourth plurality of labels from the storing host to the client host.

According to an exemplary embodiment a program element for secure storing a private message is provided, which program, when executed by a processor, is adapted to control a method comprising dividing a first message into a first plurality of shares and storing the first plurality of shares on a storing host together with a second plurality of shares of at least a second message in a mixed manner.

According to an exemplary embodiment a program element for retrieving a securely stored private message is provided, which program, when executed by a processor, is adapted to control a method comprising dividing a first message into a first plurality of shares, and storing the first plurality of shares on a storing host together with a second plurality of shares of at least a second message in a mixed manner.

It may be seen as the gist of an exemplary embodiment of the present invention that a method for securely storing and/or retrieving a message and a corresponding secure storage system is proposed, which method and secure storage system differs from the standard encryption methods in the sense that it does not solely rely on the computational complexity of the underlying cryptographic principles. Even when assumed that adversaries have infinite computational power, the storing method according to the exemplary embodiment may be more secure than known methods. In a descriptive way it may be said the secure storage system tears the data and/or messages into multiple pieces (shares), mixes them with pieces of other data (messages) and puts all those pieces into a large storage, a so called lucky-dip. Of course, an attacker with infinite computer power may reconstruct the original data (message) from all the pieces. However, he may also “reconstruct” messages that were never put in it. And since he cannot distinguish genuine messages from fake messages he has a small probability of finding the correct one. Such a message may be an electronic document or file.

One aspect of the present invention may be seen in providing a method to store private information in a database which is located on an untrusted host not owned by the data owner. Preferably, the method does not solely rely on computational assumptions common for traditional encryption schemes, but also on information theoretic assumptions. Such a method may, for example, uses secret sharing to split each data element (message) into multiple shares which are mixed with shares of other data elements (messages), possibly from other users.

The method may facilitate an efficient method for securely storing messages on an untrusted host. The messages may be divided into a plurality of shares which are stored together with other shares of other messages on the untrusted host, i.e. in a mixed manner. In particular, no information which shares belong to which specific message is stored on the host on which the messages are stored, i.e. the storing host. Thus, the method may be in particular advantages to store messages on an untrusted host. In particular, the term “mixed manner” may mean that no information is stored on the storing host which share, stored on the storing host, belongs to which message. Thus, for the storing host the different shares may not be assignable to a specific message. Preferably, a plurality of messages is added to the storing host together, e.g. with one transmitting of several pluralities of message shares. Thus, it might be possible to increase the security level even more, since the storing host does not have any information how many messages the plurality of message shares belong to and which plurality of message shares belongs to which original message.

In the following, further exemplary embodiments of the secure storing method will be described. However, these embodiments apply also for the secure storage system, the method for retrieving a securely stored message, the computer readable medium, and the program element.

According to another exemplary embodiment of the storing method the storing host is a remote host, and the method further comprises transmitting the first plurality of shares to the remote host.

According to another exemplary embodiment the method further comprises labelling each of the first plurality of shares with a respective label out of a third plurality of labels before storing the first plurality of shares on the storing host. Preferably, the labelling is done before transmitting the first plurality of shares.

By using a labelling, which is performed before the message, i.e. the shares, are transmitted to the storing host it may be possible to provide an efficient method to ensure that on the one hand the storing can be securely performed on the storing host, while on the other hand no information has to be stored on the storing host, which shares belong to which specific message. This may in particular suitable in case that several messages are transmitted to the storing host together. According to one exemplary aspect the added labels can be seen as private keys, to the data elements (message shares) for easy retrieval by the data owner.

According to another exemplary embodiment the third plurality of labels is received from the storing host.

By receiving the plurality of labels from the storing host it may be possible to ensure that each label is only used once on the storing host, so that the labelling is unambiguous. In particular, it might be advantageous to request more labels than it is necessary, i.e. the number of received labels is higher than the number of shares the message is divided into. Thus, it may be possible to hide from the storing host which labels are used as labels for one single message.

According to another exemplary embodiment the method further comprises comparing at least one of the first plurality of shares with the shares of the second plurality of shares. In case the at least one of the first plurality of shares is identical to one of the shares of the second plurality of shares the method comprises not storing the at least one of the first plurality of shares stored on the storing host and associating the label of the at least one of the first plurality of shares with the one of the shares of the second plurality of shares.

This exemplary aspect of the invention can be also described as a method which reuses shares from other data elements and/or users. That is, identical shares or data elements are only stored once on the storing host but used for different messages. This might decrease the necessary storing space on the storing host, by not substantially decreasing the security of the storing method. This comparison may be performed before transmitting the shares to the storing host, e.g. on a client host, or on the storing host itself. If the comparison is performed by the storing host, the label of the identical share, which is not stored, is preferably added to the already stored share, so that the stored share comprises two labels. If the comparison is done on the client host, the specific share, i.e. the share which is already stored on the storing host, is preferably not transmitted to the storing host again.

According to another exemplary embodiment the method further comprises increasing a reference counter for the at least one of the plurality of shares in case the at least one of the first plurality of shares is identical to one of the shares of the second plurality of shares.

To provide such a reference counter may be a suitable measure to ensure that a deletion of a single share may not cause many messages to get corrupted. This might be in particular advantageous in case the reuse of shares is allowed. Since there may be no single entity knowing which share belongs to what message, it may be impossible to safely delete a share without taking extra measures. One such measure may be the adding of the reference counter to each share. Each time a share is used as part of a newly added message, the counter may be increased and every time a corresponding message is deleted it may be decreased. To avoid that attackers, which can see the lucky-dip at one moment or at every moment, spy out which shares belong together by looking at the increase and decrease operations, these operations may be spread over time. For instance, a client may reserve a bunch of shares early in time by asking the storing host (server) to increase their reference counters. Each time the client wants to add a message he may use some of these reserved shares while not telling the server so. When deleting, the client may mix the real shares with enough reserved (but not used) shares, to provide enough security. The lucky-dip may not able to distinguish a reserved share and a share in use. The lucky-dip may only actually delete the share when the reference counter reaches zero. Other measures may use time-out mechanisms or distributed garbage collection.

In the following, further exemplary embodiments of the receiving method will be described. However, these embodiments apply also for the secure storage system, the method for securely storing a message, the computer readable medium, and the program element.

According to another exemplary embodiment of the receiving method the fourth plurality comprises more elements than the first plurality.

In other words this may mean that more shares are demanded than the message itself is comprised of so that some bogus shares may be also transmitted from the storing host. Thus, it may be possible to increase the security level, since an attacker does not know which shares actually belong to the received message and which do not belong to the message itself. So an attacker which has access to the transmission may not be able to combine the transmitted shares to obtain the original message.

According to another exemplary embodiment of the receiving method to each share stored on the storing host a reference counter is associated, wherein the reference counter counts the number of times the associated share is used as a part of a message. The method further comprises decreasing the reference counter for a specific share each time a deletion of the corresponding specific share is demanded. Preferably, the specific share on the storing host is only deleted when the reference counter is zero.

To provide such a reference counter may be a suitable measure to ensure that a deletion of a single share may cause many messages to get corrupted. This might be in particular advantageous in case the reuse of shares is allowed. Since there may be no single entity knowing which share belongs to which message, it may be impossible to safely delete a share without taking extra measures. One such measure may be the adding of the reference counter to each share. Each time a share is used as part of a newly added message, the counter may be increased and every time a corresponding message is deleted it may be decreased.

In the following, further exemplary embodiments of the secure storage system will be described. However, these embodiments apply also for the receiving method, the method for securely storing a message, the computer readable medium, and the program element.

According to another exemplary embodiment the secure storage system further comprises a client connectable to the storing host, wherein the client is adapted to divide the private message into a first plurality of message shares. Preferably, the client is adapted to associate a respective label out of a plurality of labels to each share out of the first plurality of message shares, and is further adapted to store a list of the respective labels associated with the private message. In particular, the client can be further adapted to add bogus labels to the list.

By storing a list of the labels of each message preferable only on the client it may be possible to increase the security of the storing system since no information is stored on the storing host which shares stored on the storing host belong to which specific message.

When using bogus labels while receiving a stored message it might be advantageous to use the same bogus labels each time a specific message is retrieved from the storing host in order to increase the security of the storing. By doing this it might be possible to decrease the possibility to estimate which shares are actually belonging to the message and which shares belonging to bogus labels, i.e. do not belong to the actual message.

According to another exemplary embodiment of the secure storage system the client has a higher level of security than the storing host. In particular, the client may be more trusted by the owner of the message. For example, the client may be a computer system owned by the owner of the messages himself, while the storing host, may be a database owned by another entity. Thus, the owner of the message is in duty and responsive of the security of client host and thus may know how secure the client is, while he has no direct knowing of the security level of the storing host itself.

Summarizing, it may be seen as a gist of an exemplary embodiment that a database is provided which stores several messages owned by different users into a single lucky-dip. Each message is split into multiple shares, which are mixed with shares of other messages, obscuring which shares belong together. Without any additional information it is computationally hard to retrieve the messages back. The only way to reconstruct the messages is to do a brute force search, trying all possible subsets. The number of guesses grows exponentially in the number of shares. Furthermore, the shares can be combined in so many ways that many of those recombinations look legitimate, although they have never been put into the lucky-dip. An adversary or attacker cannot do better than guessing which recombination is genuine and which recombination is fake. In order, for a legitimate user, to be able to efficiently retrieve the messages, the shares are annotated by labels. The labels may be generated and/or associated to the shares by the user and act as private keys. The labels, which typically take less space than the messages, are stored at the client site and will be used to retrieve shares belonging to the same message. To hide the relation between the labels from an eavesdropper, the genuine labels can be mixed with bogus labels. Preferably, the number of bogus label is determined in such a way that it is sufficiently large to minimize the danger that an attacker can reconstruct the original message. The choosing of the number of bogus labels may be an trade-off between security and efficiency of the system and/or method. Preferably, the method implements the standard database operations: read, add and delete.

These and other aspects of the present invention will become apparent from and elucidated with reference to the embodiment described hereinafter.

An exemplary embodiment of the present invention will be described in the following, with reference to the following drawings.

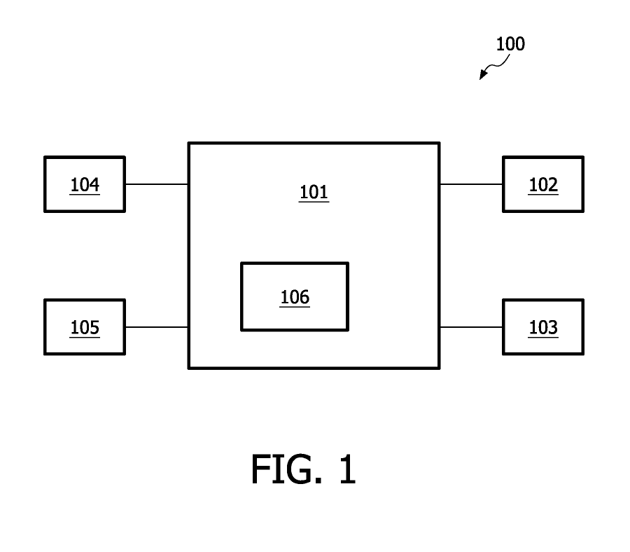

FIG. 1 shows a simplified schematic drawing of the secure storing system according to an exemplary embodiment.

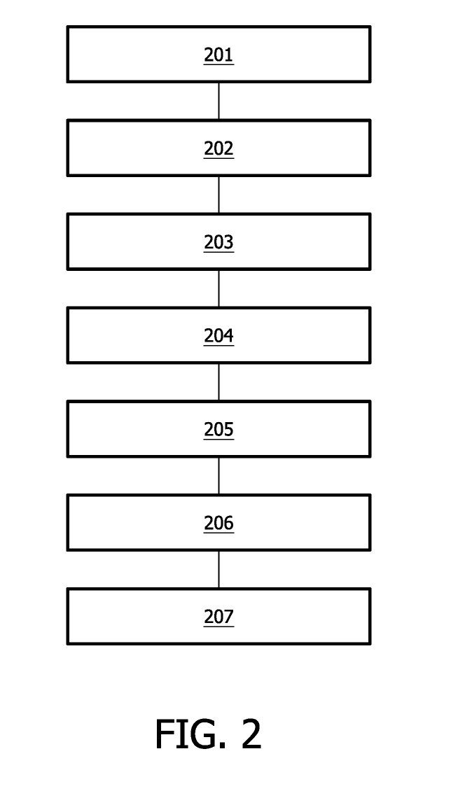

FIG. 2 shows a simplified schematic flowchart of a storing and receiving method according to an exemplary embodiment.

The illustration in the drawings is schematically. In different drawings, similar or identical elements are provided with the similar or identical reference signs.

FIG. 1 shows a simplified schematic drawing of the secure storing system 100. The secure storing system 100 comprises a storing host or database 101 and a plurality of client hosts, e.g. 102, 103, 104, 105. The client hosts are connected to the database 100 and are owned by different owners. Typically a storage capacity of the clients is smaller than the storage capacity of the storing host. The storing host 100 can be formed by a central server or database. The storing host 100 comprises a storing medium, like a hard disk 106 or the like. In this storing medium memory is allocated to store a plurality of messages owned by the owners of the different hosts. According to the exemplary embodiment, each of the messages stored in the memory are divided into a plurality of message shares and all message shares are stored in a mixed manner in this allocated memory, i.e. the messages shares are mixed which each other so that a so called lucky-dip is formed, and the storing host and the owner of the storing host has no information which message share belongs to which original message. Thus, also an attacker which may have access to the database does not know which message share belongs to which actual message.

FIG. 2 shows a simplified schematic flowchart of a storing and receiving method according to an exemplary embodiment. In a first step of the storing method a plurality of labels is received from a storing host 201. Afterwards a message is divided into a plurality of message shares by the owner of the message 202. This dividing is preferably performed on a client owned by the owner of the message. Each message share is associated with one label of the plurality of labels 203. Then the labelled message shares are send to the storing host 204. Additionally, some bogus shares may be send along with the message shares actually belonging to the message. Preferably, when transferring a message to the storing host not only shares relating a single message should be added to the storing host, in particular in case the “lucky-dip” is empty. Rather the first messages should be added as a bunch of mixed shares of different messages. If a user hast just one single message to store he can create a bunch of garbage messages or collaborate with different users. Eventually, these garbage shares can be deleted later on. At the time of transferring the message shares a list is stored on the client which message shares belonging to the stored message. Then the message shares are stored on the storage host together with other message shares of the same user and/or of different users 205. Thus, a so called lucky-dip is formed on the storing host. Optionally, on the storing host the transmitted messages shares are compared with shares already stored on the storing host. In case identical shares are already stored on the storing host these identical message shares are not again stored on the storing host, but rather reused. That is, the specific message shares are only stored once and the respective labels are associated with the already stored message shares as well. Alternatively, this comparison can be performed already on the client host, whereby it has to be noted that in this case the comparison can be only performed with message shares of the same owner. Contrary, in case the comparison is performed on the storing host, the comparison can be performed between all stored message shares, i.e. also with message shares of other users. If a reuse of message shares is performed a reference counter is associated with each message share counting the number of times the message share is used as a part of a message. This reference counter is decreased each time a respective message, i.e. the message shares, is demanded to be deleted on the storing host.

When the owner of a message desires to retrieve the message from the storing host a demand is forwarded to the storing host together with a list of all labels which shall be transmitted 206. The storing host then transmits the demanded message shares to the client 207, at which the original message can be recombined by using the list of labels which was stored on the client at the time the message was divided into message shares. Preferably, not only the message shares are demanded which actually belong to the message, but also some bogus message shares are demanded which do not belong to the actual message in order to increase the security level. The bogus message shares demanded together with the “real” message shares of the message to be retrieved can either be the same bogus message shares which were transferred to the storing host together with the real message, or can be other bogus message shares known in use, e.g. message shares of a different message of the same user or message shares of other users. Thus, an attacker does not know which message shares belonging to the actual message. In order to increase the security level even higher it may be advantageous to always demand the same bogus shares when this specific message is again transmitted to the client, i.e. the owner of this specific message.

In the following some further considerations of the method according to an exemplary embodiment are performed.

It can be assume that each message is divided into blocks of numbers in a finite field F. In a typical application this finite field will be the binary finite field, i.e. {0; 1} with binary addition. Each such block is an element of Fⁿ where n is the block length. For ease of discussion it will assumed that all messages have a fixed length equal to the block length of the shares. That is, all messages mᵢ are taken from M⊂Fⁿ. Each mᵢ is split into kεN shares, wherein N is the set of natural numbers: mᵢ=mᵢ^{(l)}⊕ . . . ⊕mᵢ^{(k)} using any secret sharing scheme.

A share mᵢ^{(j)} gets label lᵢ^{(j)}. The labels can be of any type, but it is most practical if the labels are elements of L⊂F^{s} where s is the size of the labels, which is typically much smaller than n. The server stores the lucky-dip containing the tuples (lᵢ^{(j)},mᵢ^{(j)}) and the client keeps track of which labels belong together: (i, {lᵢ^{(l)}, . . . , lᵢ^{(k)}}), i.e. that the labels (lᵢ^{(l)}, . . . , lᵢ^{(k)}) belong to the message mᵢ.

When retrieving a message mᵢ from the database, the user first retrieves the corresponding labels lᵢ^{(l)}, . . . , lᵢ^{(k)} from its own data store. These legitimate labels are mixed with bogus labels before they are sent to the server. Preferably, the bogus labels are in use in the lucky-dip, e.g. used labels of former messages of the same user or generated bogus labels of the same user, i.e. labels associated with garbage message shares not relating to a genuine or real message and generated for transferring together with a former message. This way the fact that lᵢ^{(l)}, . . . , lᵢ^{(k)} belong together is hidden from the server. The server transmits both, the legitimate shares mᵢ^{(j)} and the bogus shares. The latter ones can easily be filtered out by the client, since a list of the labels associated to the message shares of a single message is stored on the client.

Let the total number of labels requested be ck (cεN) of which only k are legitimate. Then, an attacker has

$$( \begin{matrix}ck \\ k\end{matrix} )$$

possibilities of putting together shares (i.e. ≈ο ((ck)^{k}) choices). It would be bad if the (c−1)k labels which are sent along with the real labels to retrieve mᵢ would be different each time the same message mᵢ is retrieved, because if an attacker is aware of the fact that the user is retrieving the same message twice, then he will simply take the intersection of the labels sent the first time and the second time. To prevent this, when requesting the same message twice, it is preferably make sure that the requested ck labels will always be the same for a specific message. There are various ways to accomplish this. For example, one can put each possible label in a preset group of c labels; when desiring one of the labels in this group, one asks for the data connected to each label in this group. For example, if requesting the data connected with label 1 lε{0, 1}⁵⁰, then one always requests the data connected with all labels l′ that have the first 40 bits in common.

To further increase the chaos in the lucky-dip, different messages, possibly owned by different users, can share each others shares. For instance let m₁=m₁⁽¹⁾⊕m₁⁽²⁾⊕m₁⁽³⁾, then m₂ may be defined by m₂=m₁⁽¹⁾⊕m₁⁽²⁾⊕m₂⁽¹⁾, reusing m₁⁽¹⁾ and m₁⁽²⁾. The purpose of reusing shares is twofold. On the one hand it reduces the size of the lucky-dip, since fewer shares are stored. On the other hand security is increased.

To quantify the effect of reusing shares, two lucky-dips: one with and one without reuse are compared. It is assumed that each message, except the first one, will be composed of (k−1) shares that are already in the dip (or bin), plus a new share. In this case the dip reusing shares stores k+h−1 shares (where h is the total number of messages) whereas the non-reusing dip stores all hk shares. Thus reusing shares approximately costs a factor k less size.

On the other hand: less shares reduce the security, since less k-tuples can be taken from the smaller bin. However, it is not as bad as it looks like. In the non reusing case, the lucky-dip randomly partitions its hk shares into h partitions, whereas in case of reuse an attacker does not have the advantage of a nice partitioning.

In the following reuse for securing updates is exploited:

Without reuse:

An attacker does not know which particular partition is chosen, so he has to investigate all possible partitions. The number of possibilities is calculated as follows:

$$\begin{matrix}{1}^{st} k \text{-} tuple : ( \begin{matrix}hk \\ k\end{matrix} ) , \\ {2}^{nd} k \text{-} tuple : ( \begin{matrix}hk - k \\ k\end{matrix} ) \\ … \\ {i}^{th} k \text{-} tuple : ( \begin{matrix}hk - ( i - 1 ) k \\ k\end{matrix} ) \\ … \\ {h}^{th} k \text{-} tuple : 1\end{matrix}$$

Which makes the total number of possible partitions

$${\prod }_{i = 0}^{h - 1} ( \begin{matrix}hk - ik \\ k\end{matrix} ) = {\prod }_{j = 1}^{h} ( \begin{matrix}jk \\ k\end{matrix} ) .$$

With reuse:

In case of reuse an attacker cannot rely on a nice partition. He has to take h independent k-tuples out of a lucky-dip of size k+h−1. Thus, the total number of possibilities is

$${( \begin{matrix}h + k - 1 \\ k\end{matrix} )}^{h} .$$

This number is less than the number of possibilities in case without reuse, but is still huge.

A possible threat to the storage system may be depending on the capabilities of the attackers. Three types of attackers may be distinguished.

| | see lucky-dip at a certain | see lucky-dip at every | access to |
|---|---|---|---|
| Type | moment | moment | communication |
| I | X | | |
| II | X | X | |
| III | X | X | X |

An attacker of type I (for instance an employee who steals a hard disk) cannot see any communication, while an attacker of type II (for instance a backup operator who can make frequent copies of the database) can see updates and one of type III (for instance a system operator with full control over the system) can see both updates and read operations. All attackers in that model are passive. Active attackers that modify data in transit or stored in the lucky-dip are not investigated.

In a database certain standard database operations are possible. These standard database operations are:
read;
add
delete
(modify), wherein modify can be modelled as a [symbol] delete, add [symbol] sequence and will thus not be dealt with in the following.

A database system based on the lucky-dip principles preferably takes care that the information leakage is kept low for all these operations. Preferably, a trade-off is decided on between security and efficiency. The lucky-dip parameters may allow this trade-off to be specified precisely. All operations have their own security threats and consequences. Each of them is summarised below:

### Read:

When only attackers of types I and II (table above) are to be taken care of, no special precautions are needed. However, if there are type III attackers around, just asking for the k shares, may leak the whole message. To hide the fact that the k shares belong together, noise can be introduced by adding b bogus labels to the query. This way, the information leakage may be restricted to the fact that within the k+b shares a message (split over k shares) is hidden. However, the total number of possible messages is

$$( \begin{matrix}k + b \\ k\end{matrix} )$$

and can be very large for a sufficiently large b, which may act as the trade-off parameter between security and efficiency. When a message is being retrieved multiple times, it is advisable to use the same set of k+b shares each time. Not doing so, an attacker may intersect two sets of shares belonging to two messages guessed to be the same. If the messages are indeed the same the intersection will almost certainly reveal the k shares.

### Add:

A type I attacker is unable to see any updates. Therefore, no precautions are needed against him. A type II attacker may be best misled by allowing reuse of shares. When k-s shares are taken from the ones already in the lucky-dip, only s (for example s=1) shares have to be added. A type II attacker has no clue which other shares they belong to. This is not true for a type III attacker, since he can see the retrieval of the k-s shares preceding the update. To mislead a type III attacker, it is preferable to add a plurality of messages at once. Mixing t messages will result in tk shares. The total number of recombinations is

$${\prod }_{j = 1}^{t} ( \begin{matrix}j k \\ k\end{matrix} )$$

which may be enough when t is sufficiently large. When the number of messages to be added is small, then mixing the real messages with bogus shares may increase the security. To prevent that the bogus shares allocate valuable storage space, the bogus shares may be chosen from the ones already in the lucky-dip. When the lucky-dip allows reuse of shares, an attacker cannot distinguish a bogus share and a reused share.

### Delete:

Although the messages to be deleted are old or incorrect, which are possible reasons for deleting the messages, it is still not a good idea to reveal the old messages. If the number of messages to be deleted (t) is sufficiently large, the messages are mixed well enough to prevent repartitioning the tk shares into the t original messages. When reuse of shares is allowed, deletion of a single share may cause many messages to get corrupted. Since there may be no single entity knowing which share belongs to whom, it may be impossible to safely delete a share without taking extra measures. One such measure may be the adding of the reference counter to each share. Each time a share is used as part of a newly added message, the counter may be increased and every time a corresponding message is deleted it may be decreased. To avoid that attackers which can see the lucky-dip at one moment or at every moment spy out which shares belong together by looking at the increase and decrease operations, these operations may be spread over time. For instance, a client may reserve a bunch of shares early in time by asking the storing host (server) to increase their reference counters. Each time the client wants to add a message he may use some of these reserved shares while not telling the server so. When deleting, the client may mix the real shares with enough reserved (but not used) shares, to provide enough security. The lucky-dip may not able to distinguish a reserved share and a share in use. The lucky-dip may only actually delete the share when the reference counter reaches zero. Other measures may use time-out mechanisms or distributed garbage collection.

Summarizing, a gist of an exemplary embodiment may be seen in that that a database is provided which stores several messages owned by different users into a single lucky-dip. Each message is split into multiple shares, which are mixed with shares of other messages, obscuring which shares belong together. Without any additional information it is computationally hard to retrieve the messages back.

It should be noted that the term “comprising” does not exclude other elements or steps and the “a” or “an” does not exclude a plurality. Also elements described in association with different embodiments may be combined. It should also be noted that reference signs in the claims shall not be construed as limiting the scope of the claims.

1. A method for securely storing a message, the method comprising:
dividing a first message into a first plurality of shares; and
storing the first plurality of shares on a storing host together with a second plurality of shares of at least a second message, wherein the storing is performed in a mixed manner.

2. The method according claim 1, wherein the storing host is a remote host, and wherein the method further comprises:
transmitting the first plurality of shares to the remote host.

3. The method according to claim 1, the method further comprising:
labelling each of the first plurality of shares with a respective label out of a third plurality of labels before storing the first plurality of shares on the storing host.

4. The method according claim 3,
wherein the labelling is done before transmitting the first plurality of shares.

5. The method according to claim 1, further comprising:
receiving the third plurality of labels from the storing host.

6. The method according to claim 1, further comprising:
comparing at least one of the first plurality of shares with the shares of the second plurality of shares, and
in case the at least one of the first plurality of shares is identical to one of the shares of the second plurality of shares:
not storing the at least one of the first plurality of shares on the storing host; and
associating the label of the at least one of the first plurality of shares with the one of the shares of the second plurality of shares.

7. The method according claim 6, further comprising:
in case the at least one of the first plurality of shares is identical to one of the shares of the second plurality of shares:
increasing a reference counter for the at least one of the plurality of shares.

8. A method for retrieving a securely stored message, wherein the securely stored message is divided into a first plurality of shares, which is stored on a storing host in a mixed manner, wherein each of the shares is labelled:
sending a list comprising a fourth plurality of labels from a client to the storing host; and
transmitting the shares associated with the labels of the fourth plurality of labels from the storing host to the client host.

9. The method according to claim 8,
wherein the fourth plurality comprises more elements than the first plurality.

10. The method according to claim 8, wherein to each share stored on the storing host a reference counter is associated, the reference counter counts the number of times the associated share is used as a part of a message, the method further comprising:
decreasing the reference counter for a specific share each time a deletion of the corresponding specific share is demanded.

11. The method according claim 10, further comprising:
deleting the specific share on the storing host only when the reference counter is zero.

12. Secure storage system for private messages, the system comprising:
a storing host,
wherein the storing host is adapted to store a plurality of private messages in a mixed manner, wherein each of the plurality of private messages is divided into a plurality of message shares.

13. The secure storage system according claim 12, further comprising:
a client connectable to the storing host,
wherein the client is adapted to divide the private message into a first plurality of message shares.

14. The secure storage system according claim 13;
wherein the client is adapted to associate a respective label out of a plurality of labels to each share out of the first plurality of message shares; and
wherein the client is further adapted to store a list of the respective labels associated with the private message.

15. The secure storage system according claim 14,
wherein the client is further adapted to add bogus labels to the list.

16. The secure storage system according to claim 13,
wherein the client has a higher level of security than the storing host.

17. A computer readable medium in which a program for secure storing a private message is stored, which program, when executed by a processor, is adapted to control a method comprising:
dividing a first message into a first plurality of shares; and
storing the first plurality of shares on a storing host together with a second plurality of shares of at least a second message in a mixed manner.

18. A computer readable medium in which a program for retrieving a securely stored private message, which program, when executed by a processor, is adapted to control a method comprising:
sending a list comprising a fourth plurality of labels from a client to the storing host; and
transmitting the shares associated with the labels of the fourth plurality of labels from the storing host to the client host.

19. A program element for secure storing a private message is stored, which program, when executed by a processor, is adapted to control a method comprising:
dividing a first message into a first plurality of shares; and
storing the first plurality of shares on a storing host together with a second plurality of shares of at least a second message in a mixed manner.

20. A program element for retrieving a securely stored private message, which program, when executed by a processor, is adapted to control a method comprising:
dividing a first message into a first plurality of shares; and
storing the first plurality of shares on a storing host together with a second plurality of shares of at least a second message in a mixed manner.
